(19) United States
(12) Patent Application Publication
(10) Pub. No.: US 2007/0157212 A1
(43) Pub. Date: Jul. 5, 2007

(54) Context key routing for parallel processing in an application serving environment

(76) Inventors: Douglas C. Berg, Rochester, MN (US); Erik A. Daughtrey, Durham, NC (US); Donald P. Pazel, Montrose, NY (US)

Correspondence Address: IBM CORP. (RALEIGH SOFTWARE GROUP);c/o Rudolf O Siegesmund Gordon & Rees, LLP, 2100 Ross Avenue, Suite 2600, DALLAS, TX, 75201, US

(21) Appl. No.: 11/325,151

(22) Filed: Jan. 4, 2006

(51) Int. Cl. G06F 9/46

(52) U.S. Cl. 719/313

(57) ABSTRACT

In alternate embodiments, the invention is a message-passing process for routing communications between a transmitting parallel process and a receiving parallel process executing in an application server environment, or a machine or computer-readable memory having the message-passing process programmed therein, the message-passing process comprising: linking a context key to an addressable computing resource in the application server environment; linking the receiving parallel process to the context key; receiving a communication from the transmitting parallel process, wherein the communication transmits the context key; and routing the communication to the addressable computing resource linked to the context key.

### FIELD OF THE INVENTION

The present invention provides for an electrical computer or digital data processing system or corresponding data processing method including apparatus or steps for exchanging data or messages between two executing programs or processes, independent of the hardware used in the communication. More particularly, the present invention comprises apparatus or steps for exchanging data to support a parallel programming model in a distributed processing environment.

### BACKGROUND OF THE INVENTION

Traditionally, software has been designed for serial processing of data. In serial processing, a single computer having a single processor executes one software instruction at a time. Sometimes, though, large computational or data-driven problems may be made more tractable by breaking the problem down into smaller tasks that can be processed in parallel using multiple computing resources. Parallel processing resources typically include single computers with multiple processors, any number of networked computers, or any combination of both. In general, processes that comprise a parallel application need to communicate with each other, i.e. exchange data with each other. Accordingly, a parallel processing system must provide some mechanism for inter-process communication.

Message passing is one popular programming model that supports inter-process communication. The Message Passing Interface (MPI) has become the de facto standard for message passing. MPI is the first standardized, vendor-independent specification for message passing libraries.

MPI uses objects called “communicators” and “groups” to define which processes may communicate with each other. A group is an ordered set of processes. A communicator is a group of processes that may communicate with each other. The differences between a communicator and a group are subtle. From a programmer's perspective, groups and communicators are virtually indistinguishable.

MPI libraries generally support at least two common message passing patterns. The first often is described as a “scatter/gather” pattern, and the second is a “collaborative” or “peer-to-peer” pattern.

FIG. 1 illustrates the scatter/gather pattern, in which a client issues messages to one or more processes in a group. Each process also may send a message to the client upon completion. Messages between the client and processes are exchanged asynchronously and each process executes independently upon receiving a message, resulting in parallel processing.

FIG. 2 illustrates the peer-to-peer pattern, in which processes in a group pass messages to each other. Again, the processes in the group exchange messages asynchronously and they execute independently, resulting in parallel processing.

Thus, message passing technology provides a programming model for the inter-process communication necessary in most parallel processing applications. But conventional message passing technology, such as MPI, also requires a complete library infrastructure dedicated exclusively to routing the inter-process communications of those applications.

Many application serving environments, however, do provide an infrastructure for routing data to targeted computing resources. A popular example of such an application serving environment is the WEBSPHERE Application Server marketed by International Business Machines Corp. In such an application serving environment, client requests are routed to various computing resources for the purpose of balancing resource workloads and ensuring resource availability. Contemporary application servers, though, do not support the inter-process communication required for parallel processing applications.

Accordingly, the state of the art could be advanced if message passing systems could leverage the existing routing infrastructure of an application serving environment to enable inter-process communications using shared resources.

### SUMMARY OF THE INVENTION

The invention is a useful improvement to a process, machine, and manufacture for communicating data between two programs or processes executing in parallel, independent of the hardware used in the communication.

In alternate embodiments, the invention is a message-passing process for routing communications between a transmitting parallel process and a receiving parallel process executing in an application server environment, or a machine or computer-readable memory having the message-passing process programmed therein, the message-passing process comprising: linking a context key to an addressable computing resource in the application server environment; linking the receiving parallel process to the context key; receiving a communication from the transmitting parallel process, wherein the communication transmits the context key; and routing the communication to the addressable computing resource linked to the context key.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 illustrates a scatter/gather pattern for inter-process communication;

FIG. 2 illustrates the peer-to-peer pattern for inter-process communication;

FIG. 3 illustrates a prior art two-tiered computer system;

FIG. 4 illustrates a prior art web architecture;

FIG. 5 illustrates a prior art multi-tiered computer system;

FIG. 6 illustrates an exemplary EIS having at least one application server, in which the principles of the present invention may be implemented;

FIG. 7 illustrates the concept of workload management in an exemplary EIS;

FIG. 8 illustrates the flow of client requests in an exemplary EIS having a partition facility;

FIG. 9 is a flowchart demonstrating the general operation of the present invention during application initialization;

FIG. 10 illustrates the general operation of the present invention in support of message passing between processing members; and

FIG. 11 illustrates an alternate embodiment of the present invention in support of message passing between processing members.

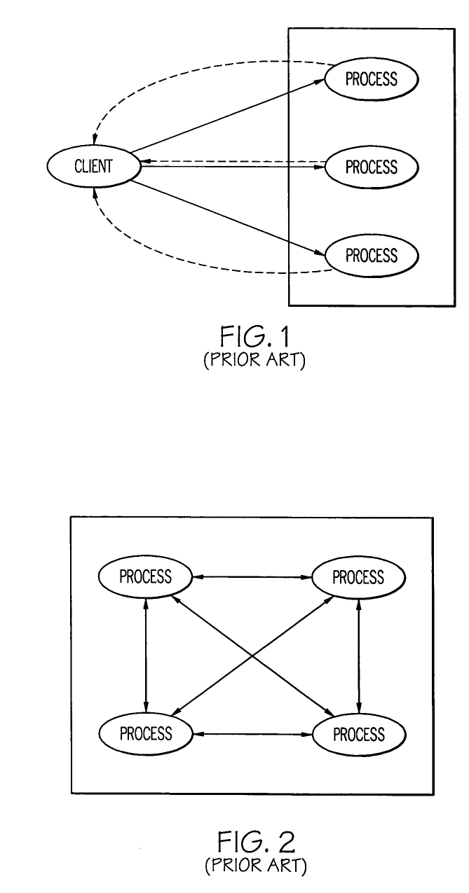

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “context key manager” program. Preferably, the context key manager is a component of an application serving environment, which is described in more detail below.

The Application Serving Environment

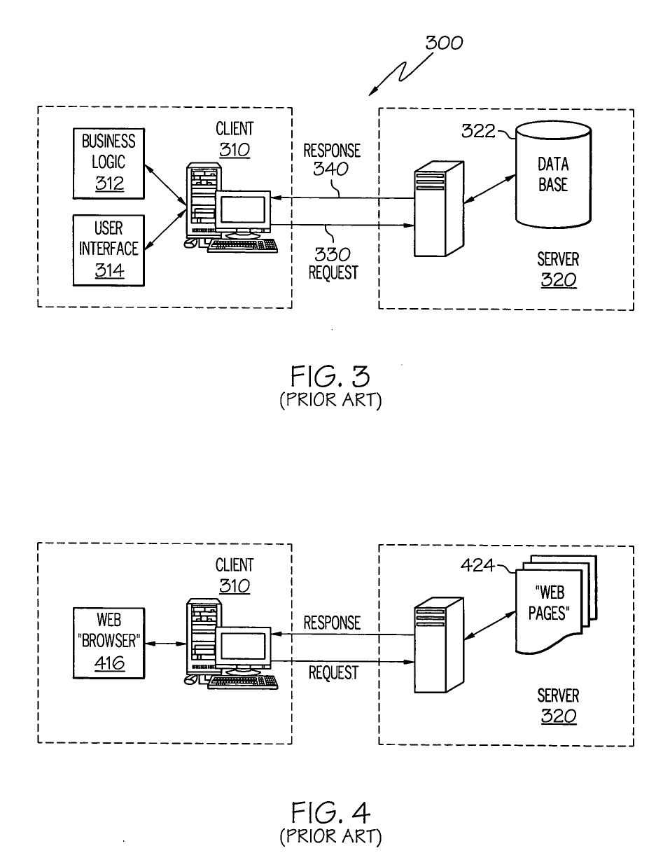

In a two-tier computer system, a server tier stores and manages data, while a client tier provides a user interface to the data in the server tier, as illustrated in FIG. 3. A conventional client tier also is responsible for implementing most of the business logic or data processing. In general, a client and a server rely on a request/response model for communicating with each other, in which the client sends a request (for data or other resources) to a server, and the server responds to the client. Note that in this context, the terms “client” and “server” refer to the hardware and software of a “host” that implements each tier's respective functions. The term “host” generally refers to a distinct physical entity (often a single computer) that is connected to a network. FIG. 3 depicts a classic embodiment of the two-tier architecture, in which a client provides the user interface and business logic, and a database server maintains the data and processes a client's request to retrieve or update the data. More particularly, two-tier client/server architecture 300 has a server tier in the form of server 320 that stores and manages data stored in database 322. A client tier in the form of client 310 provides user interface 314 for viewing and manipulating data maintained by server 320. Client 310 also is responsible for implementing most of the business logic 312 required for data processing. Server 320 processes request 330 to retrieve or update the data in database 322 and sends response 340 to client 310.

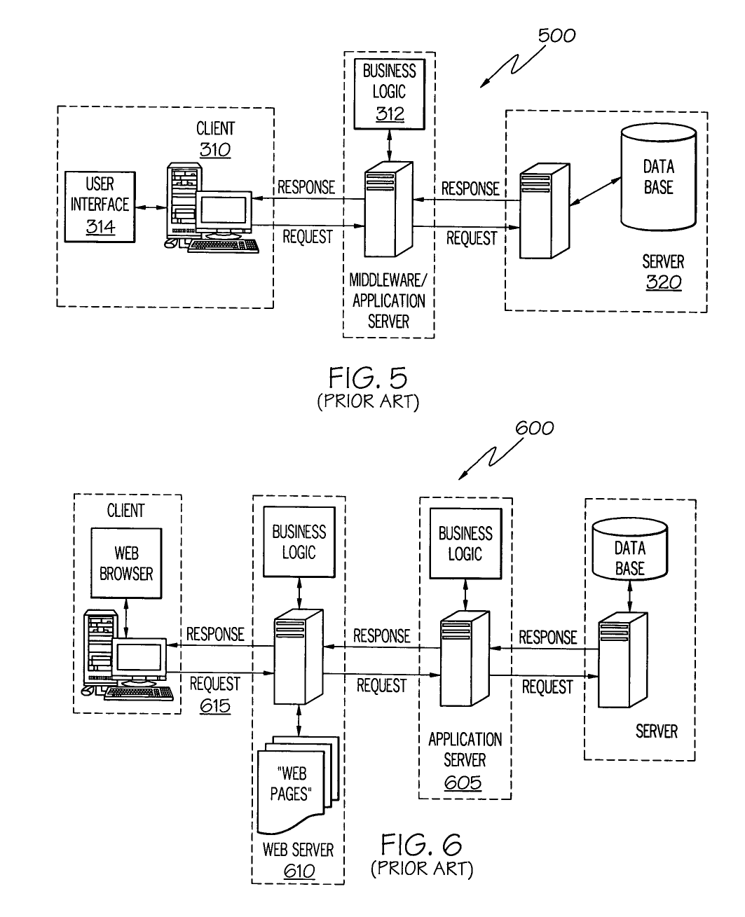

Probably the most prolific example of a tiered, client/server architecture is the World Wide Web (“the web”). Originally, the web comprised only two tiers—web servers and web clients (more commonly known as web “browsers”). FIG. 4 depicts the original web architecture, which is almost identical to the classic database architecture depicted in FIG. 3. In this case, however, user interface 314 is replaced by a web browser 416 and database 322 is replaced by web pages 424. Early incarnations of server 320 merely provided access to static web pages 424 by retrieving them and sending them over the network to the client 310, and the client 310 did nothing more than request and display them. Generally, though, web browser 416 may request any type of web resource that is available to server 320. Every web resource is associated with a Uniform Resource Indicator (URI), which uniquely identifies the resource. More particularly, the URI of a web page 424 identifies the location of server's 320 host, and the name and location of web page 424 within server's 320 file system. Consequently, the URI of a web page 424 also is known as a Uniform Resource Locator (URL).

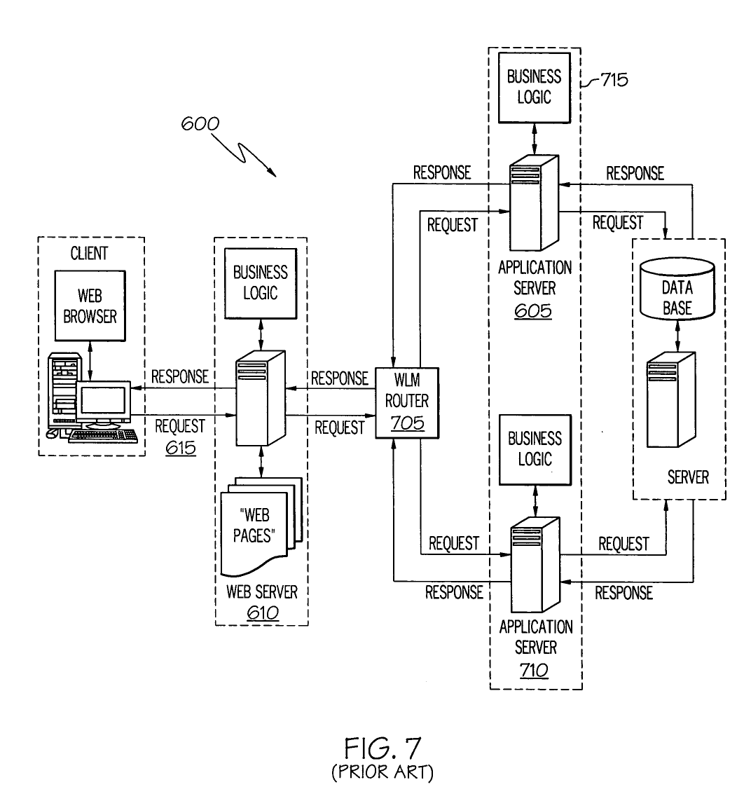

Although the two-tier architecture has enjoyed much success over the years, sophisticated multi-tier client/server systems slowly have displaced this traditional model. As FIG. 5 illustrates, a multi-tier system such as multi-tier system 500 places at least one intermediate (or “middleware”) component between client 310 and server 320. Generalized “n-tier” systems include n layers of software that provide a different layer of services at varying levels of detail to the layers above and beneath them, where n is any number. While client 310 tier generally retains its traditional responsibility for implementing user interface 314, one or more middle tiers implement business logic 312. Additional tiers usually implement the traditional server 320 tier functions, which include data management and retrieval.

A middleware component that implements business logic is referred to commonly as an “application server.” More generally, though, an application server is any program that is capable of responding to a request from a client application. An exemplary application server is a JAVA Virtual Machine (JVM), from Sun Microsystems, Inc. As used herein, an “application serving” environment is any multi-tier computer system having at least one application server.

Clearly, there is some functional overlap between clients, web servers, application servers, and database servers, with each component exhibiting unique advantages. In particular, ubiquitous web browsers such as MOZILLA, NETSCAPE, and INTERNET EXPLORER provide inexpensive (if not free), cross-platform user interfaces that comply (usually) with standard formats (e.g. HTML) and protocols (e.g. HTTP). Similarly, web servers generally offer a cross-platform, standard-compliant means of communicating with the browsers; application servers provide cross-platform access to customized business logic; and database servers provide cross-platform access to enterprise data. Today, an enterprise information system (EIS) generally integrates each of these components, thus capturing the best of all worlds and providing an architecture for implementing distributed, cross-platform enterprise applications. FIG. 6 depicts one embodiment of exemplary EIS 600 having an application serving environment, in which the principles of the present invention may be implemented. In exemplary EIS 600, application server 605 collaborates with web server 610 to return a dynamic, customized response to client request 615. Application code, including servlets, enterprise beans, and supporting classes, runs in application server 605.

Application server 605 supports asynchronous messaging. In an embodiment of the invention wherein application server 605 is a JVM, the messaging infrastructure is based on the JAVA Message Service (JMS). The JMS functions of the default message service in application server 605 are served by one or more messaging engines that run within application server 605.

In an EIS, a “node” is a logical grouping of servers. A node usually corresponds to a logical or physical computer system having a distinct network address. Nodes cannot span multiple computers.

A “node group” is a logical grouping of nodes. A node may belong to more than one node group. Each node within a node group needs to have similar software, available resources, and configuration to enable servers on those nodes to serve the same applications.

A “cluster” also is a logical grouping of servers. Each server in a cluster is referred to as a cluster “member.” A cluster may contain nodes or individual application servers. Each member may reside on a different host, but all members of a given cluster must belong to the same node group. Thus, a node group defines a boundary for cluster organization.

Likewise, a “cell” also is a logical group of one or more nodes. A cell is a configuration concept—a way for administrators to logically associate nodes with one another. Administrators define a cell according to the specific criteria of a given enterprise. A cell may have any number of clusters, or no clusters.

A cell must have at least one “core group” of clusters, though. By default, a cell has a single core group, referred to here as the “default core group.” All members of one cluster included in a core group also are members of the core group. Individual application servers that are not members of a cluster also may be defined as a member of a core group.

Core groups (within or across cells) communicate with each other using the “core group bridge service.” The core group bridge service uses access point groups to connect the core groups. A core group access point is a collection of server, node, and transport channel chain combinations that communicate for the core group. Each core group has one or more defined core group access points. The default core group has one default core group access point. The node, server, and transport channel chain combinations that are in a core group access point are called “bridge interfaces.” A host having a bridge interface is referred to as a “core group bridge server.” The transport channel chain defines the set of channels that are used to communicate with other core group bridge servers. Each transport channel chain has a configured port that the core group bridge server uses to listen for messages from other core group bridge servers. Each core group access point must have at least one core group bridge server. The core group bridge server provides the bridge interface for each core group access point.

Workload Management

Workload management is a familiar concept in an application server environment. Workload management optimizes the distribution of client requests to application servers. A workload management router program distributes incoming requests to the application servers that can most effectively process the request.

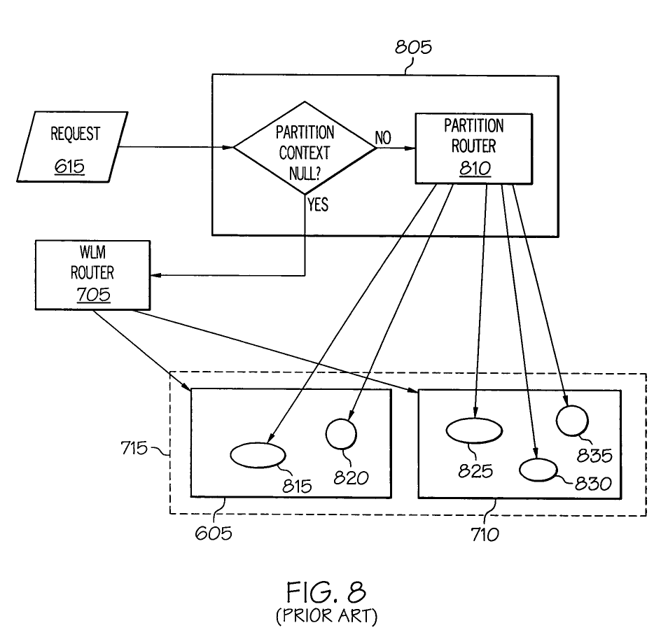

FIG. 7 illustrates the workload management concept in an alternate embodiment of exemplary EIS 600 having a workload management (WLM) router and multiple application servers organized into a cluster. In FIG. 7, WLM router 705 intercepts request 615 before it reaches application server 605 or application server 710. WLM router 705 then routes request 615 to one of the application servers, often based on assigned server weights. Application server 605 and application server 710 belong to cluster 715.

High Availability

Workload management also can provide a “high availability” (HA) environment. In an HA environment, an HA manager program provides failover services when an application server is not available, improving application availability. An HA manager instance runs on every application server in an HA environment, managing HA groups of cells and clusters. As already described, a cell can be divided into more than one core group. An HA group cannot extend beyond the boundaries of a core group. Each HA manager instance establishes network connectivity with all other HA manager instances in the same core group, using the core group bridge service. The HA manager transport channel provides mechanisms that allow an HA manager instance to detect when other members of the core group start, stop, or fail.

Within a core group, HA manager instances are elected to coordinate HA activities. An instance that is elected is known as a core group “coordinator.” The coordinator is highly available itself, such that if a process that is serving as a coordinator stops or fails, another instance is elected to assume the coordinator role without loss of continuity. The coordinator is notified as core group processes start, stop, or fail, and knows which processes are available at any given time. The coordinator uses this information to ensure that the component keeps functioning.

An HA manager also provides a messaging mechanism (commonly referred to as the “bulletin board”) that enables processes to exchange information about their current state. Each process sends or posts information related to its current state to the bulletin board, and can register to be notified when the state of the other processes change. The WLM router uses the bulletin board to build and maintain routing table information. Routing tables built and maintained using the bulletin board are highly available.

An HA group is created dynamically when an application calls the HA manager to join a group. The calling application must provide the name of the HA group. If the named HA group does not exist, the HA manager creates one.

Every HA group has a unique name. Because any application can create a high availability group, it is the HA group name that ties a given cell or cluster to a particular HA group.

An HA manager keeps track of the state of each member of an HA group. An HA group member may be idle, active, or disabled. Typically, an HA group member is either idle or active. A member that is idle is not assigned any work, but is available as a backup if a member that is active fails. A member that is active is designated as the member to handle the HA group's workload.

Partition Facilities

A “partition” is another useful concept in a high availability, application server environment. A partition is a uniquely addressable endpoint within a cluster. A partition is not a server, though. A partition does have a life cycle, and is managed by an HA manager. A partition is created dynamically at startup during a server's initialization, and then available for client applications to use as a target endpoint when in an active state. To become active, the HA manager moves the partition from an idle state to an active state through a management transition.

A partition may be activated on any cluster member. The HA manager guarantees there is a single instance of an active partition in the cluster at a given time. The HA manager also may move a partition from one cluster member to another. When the HA manager moves a partition, the partition changes states on each cluster member. For example, the partition can be deactivated on the original cluster member, and it can be activated on the new target cluster member.

Optionally, a partition can be associated with a “partition alias.” A partition alias provides more flexible context-based routing for a partition.

A “partition facility” supports the concept of partitioning for enterprise beans, web traffic, and database access. It is both a programming framework and a system management infrastructure. The primary advantage of partitioning is to specifically control resources during cluster member activities. A partition facility can route requests to a specific application server that has exclusive access to some computing resource, such as a dedicated server process or a database server that handles a specific data set. The endpoint receiving the work is still highly available. Consequently, a partitioning facility offers functionality to route work to a particular cluster member.

Relationship between High Availability & Partitioning

A single partition is actually an HA group. For example, when an application creates a partition, it is created on each member of an HA group.

Thus, given the above description of a preferred embodiment of an EIS, it should be clear that an HA manager manages highly available groups of application servers and partitions. As cluster members are stopped, started, or fail, the HA manager monitors the current state and adjusts the state as required. The core group, group coordinator, and policy functions enable the key functions that an HA manager provides.

Routing

FIG. 8 illustrates how client requests are routed to a particular partition in a cluster in the environment just described. In FIG. 8, request 615 is sent to partition facility 805. Partition facility determines if request 615 includes a partition context, which identifies a specific partition. If request 615 includes a partition context, then partition facility 805 routes the request to partition router 810. Partition router 810 then routes request 615 to the specific partition identified by the partition context, which may be partition 815, 820, 825, 830, or 835. If request 615 does not include a partition context, then partition facility 805 sends the request to WLM router 705. WLM router then routes request 615 to either application server 605 or application server 710, as described above with reference to FIG. 7.

The Context Key Manager

The context key manager of the present invention leverages the environment described above—namely, a highly available application server environment with workload management and partitioning facilities—to enable message passing between parallel processes. Before the context key manager is called, though, and application is parallelized either through automated means or program design, identifying the number of parallel application members (PAMs) that is appropriate for the application. Each PAM represents an addressable computing resource capable of participating in a distributed (i.e. parallel) computation.

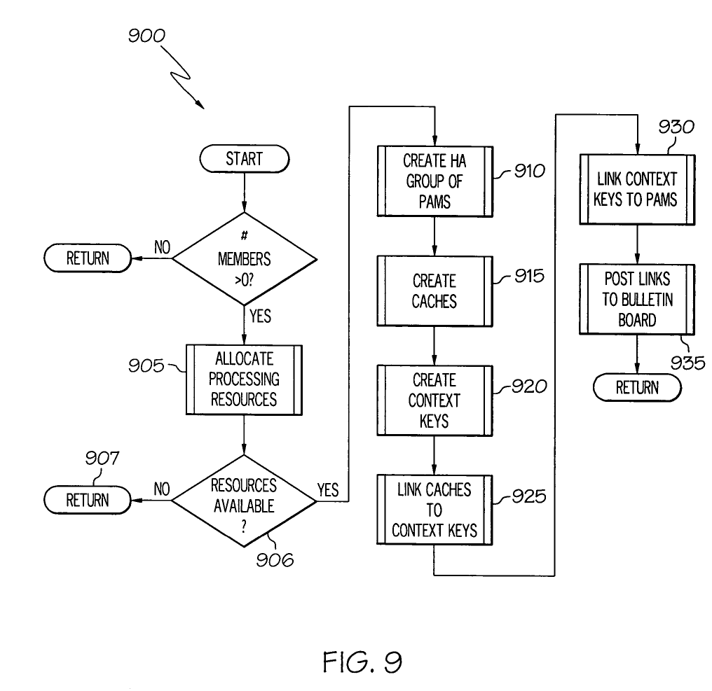

Thus, as FIG. 9 illustrates, context key manager 900 allocates processing resources for PAMs when called by a parallelized application (905). Context key manager 900 either negotiates with the infrastructure of the application serving environment for resources, or relies upon the infrastructure's explicit allocation. If there are insufficient resources available (906), context key manager 900 returns an error to the calling application (907). Context key manager 900 then creates an HA group of PAMs (910), and a message cache for each PAM (915). Next, context key manager 900 creates context keys for each message cache (920), links each message cache to a context key (925), and links each context key to a PAM (930). The links are posted to the HA manager's bulletin board (935), from which the WLM maintains a routing table.

More than one application may be may be running in the same HA group, so context keys must be unique for each PAM. One useful approach is to use a standard hierarchical name convention for context keys. For instance, a name convention may be “/Parallel/ApplicationName/AppInstanceID/PAM-ID.” Flexibility is the most significant advantage of using context keys over direct references to message caches. The infrastructure of the application serving environment is free to associate a context key with whatever routing information is necessary to ensure availability and differentiation. One alternative to the hierarchical naming convention would be to link a context key to a network port, and use the context key itself to identify the message cache.

Additionally, new relationships may be formed among PAMs by creating new HA groups. In this additional embodiment, an exemplary naming convention would be “/Parallel/ApplicationName/AppInstanceID/GroupName/PAM-ID.” Additional HA groups would allow PAMs to participate logically in various configurations based on the original group. Each additional group would logically have unique message caches related to the default group message caches.

Alternatively, the context key manager sets up a partition for each PAM instead of an HA group of PAMs. If a partition is used, then the context key manager creates a context key for each partition, links each partition to a context key, and links each context key to a PAM. A partition may represent a message cache. The partition router handles communications between PAMs.

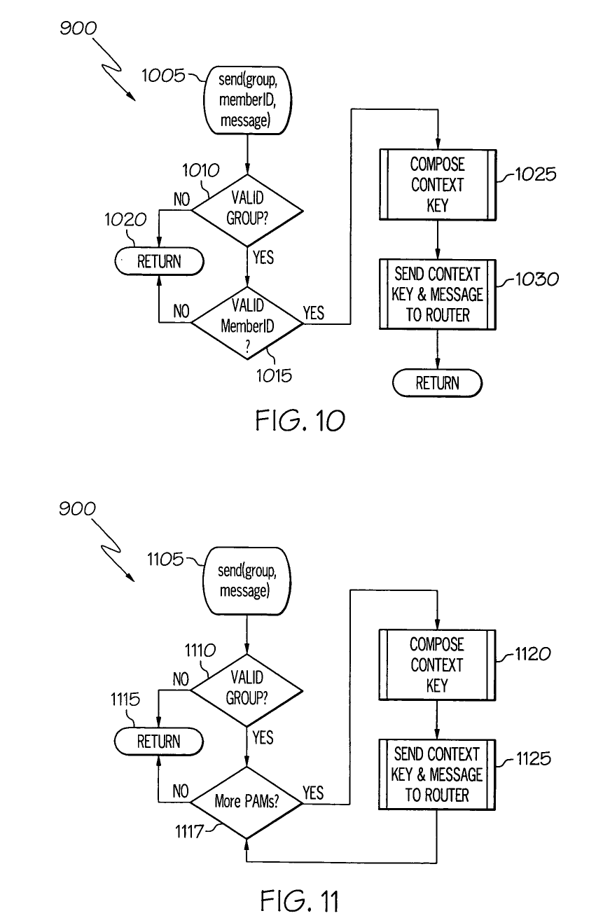

FIG. 10 illustrates the general operation of context key manager 900 in support of message passing between PAMs. Message passing is initiated by a PAM via an application programming interface (API) implemented in the application serving environment. A typical API call requires as parameters a PAM-ID and message data, such as in “send(PAM-ID, message).” The API call also may specify a GroupName, if more than one group is in use. Referring to FIG. 10 for illustration, context key manager 900 is activated when a PAM makes an API call (1005). In FIG. 10, the call specifies a group, as well as the PAM-ID and message. Consequently, context key manager first verifies the validity of the group (1010) and PAM-ID (1015). If context key manager 900 determines that either is invalid, context key manager 900 returns an error to the calling PAM (1020). If both are valid, then context key manager 900 composes the context key (1025) from the specified GroupName and PAM-ID (assuming the hierarchical naming convention described above has been implemented). Finally context key manager 900 passes the context key and message data to the proper routing mechanism (1030) of the underlying application serving environment, which in alternate embodiments of the present invention may be either a WLM router or a partition router.

In an alternative embodiment, a PAM can initiate a broadcast message destined for all PAMs in a specified group. FIG. 11 is a flowchart that illustrates the general operation of context key manager 900 in this alternative embodiment. A typical API call for a broadcast message would be “send(group, message).” Upon receiving a broadcast message API call (1105), context key manager first checks the validity of the specified group (1110), and returns an error if the specified group is invalid (1115). Otherwise, context key manager 900 composes a key for each PAM in the group (1117-1120), based on each PAM-ID and the specified GroupName. For each composed key (1117), context key manager 900 passes the context key and the message to the proper routing mechanism (1125), which, again, may either be a WLM router or a partition router.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A message-passing process for routing communications between a transmitting parallel process and a receiving parallel process executing in an application server environment, the message-passing process comprising:
linking a context key to an addressable computing resource in the application server environment;
linking the receiving parallel process to the context key;
receiving a communication from the transmitting parallel process, wherein the communication transmits the context key; and
routing the communication to the addressable computing resource linked to the context key.

2. The message-passing process of claim 1 wherein the addressable computing resource is a logical partition in a memory accessible to the transmitting parallel process and the receiving parallel process.

3. The message-passing process of claim 1 wherein the addressable computing resource is a cache associated with the receiving parallel process.

4. The message-passing process of claim 1 wherein the addressable computing resource is a partition facility having a routing table that links the context key to a logical partition in the application server environment, and the message-passing process further comprises routing the communication from the partition facility to the logical partition.

5. The message-passing process of claim 1 wherein:
the receiving parallel process is a member of a group;
the context key comprises a member key and a group key;
the receiving parallel process is linked to the member key; and
the group is linked to the group key.

6. The message-passing process of claim 5 wherein the addressable computing resource is a logical partition in a memory accessible to the transmitting parallel process and the receiving parallel process.

7. The message-passing process of claim 5 wherein the addressable computing resource is a partition facility having a routing table that links the context key to a logical partition in the application server environment, and the message-passing process further comprises routing the communication from the partition facility to the logical partition.

8. A parallel processing machine comprising:
a processor;
a memory coupled to the processor;
an application serving environment in the memory operable to cause the processor to respond to a request from a client application; and
a context key manager program in the memory operable to cause the processor to perform a method, the method comprising
allocating resources from the processor, the memory, and the application serving environment for a first parallel process and a second parallel process;
linking a context key to an addressable computing resource in the application serving environment;
linking the second parallel process to the context key;
receiving a communication from the first parallel process, wherein the communication transmits the context key; and
routing the communication to the addressable computing resource linked to the context key.

9. The machine of claim 8 wherein the step of allocating resources comprises negotiating with the application serving environment for resources.

10. The machine of claim 8 wherein the addressable computing resource is a logical partition in the memory accessible to the first parallel process and the second parallel process.

11. The machine of claim 8 wherein the addressable computing resource is a cache associated with the second parallel process.

12. The machine of claim 8 wherein the addressable computing resource is a partition facility having a routing table that links the context key to a logical partition in the application server environment, and the context key manager program further causes the processor to route the communication from the partition facility to the logical partition.

13. The machine of claim 8 wherein:
the second parallel process is a member of a group;
the context key comprises a member key and a group key;
the second parallel process is linked to the member key; and
the group is linked to the group key.

14. A computer-readable memory for causing a computer to perform a message-passing process for routing communications between a transmitting parallel process and a receiving parallel process executing in an application server environment, the message-passing process comprising:
linking a context key to an addressable computing resource in the application server environment;
linking the receiving parallel process to the context key;
receiving a communication from the transmitting parallel process, wherein the communication transmits the context key; and
routing the communication to the addressable computing resource linked to the context key.

15. The computer-readable memory of claim 14 wherein the addressable computing resource is a logical partition in a memory accessible to the transmitting parallel process and the receiving parallel process.

16. The computer-readable memory of claim 14 wherein the addressable computing resource is a cache associated with the receiving parallel process.

17. The computer-readable memory of claim 14 wherein the addressable computing resource is a partition facility having a routing table that links the context key to a logical partition in the application server environment, and the message-passing process further comprises routing the communication from the partition facility to the logical partition.

18. The computer-readable memory of claim 14 wherein:
the receiving parallel process is a member of a group;
the context key comprises a member key and a group key;
the receiving parallel process is linked to the member key; and
the group is linked to the group key.

19. The computer-readable memory of claim 18 wherein the addressable computing resource is a logical partition in a memory accessible to the transmitting parallel process and the receiving parallel process.

20. The computer-readable memory of claim 18 wherein the addressable computing resource is a partition facility having a routing table that links the context key to a logical partition in the application server environment, and the message-passing process further comprises routing the communication from the partition facility to the logical partition.
